(19) United States
(12) Patent Application Publication
(10) Pub. No.: US 2026/0302177 A1
(43) Pub. Date: Oct. 1, 2026

(54) PHOSPHORUS-CARBON ELECTRODE ACTIVE MATERIAL COMPOSITE FOR SODIUM-ION BATTERY, AND SODIUM-ION BATTERY

(71) Applicant: TOYOTA JIDOSHA KABUSHIKI KAISHA, Toyota-shi (JP)

(72) Inventor: Yosuke TOKUDA, Susono-shi (JP)

(73) Assignee: TOYOTA JIDOSHA KABUSHIKI KAISHA, Toyota-shi (JP)

(21) Appl. No.: 19/444,422

(22) Filed: Jan. 9, 2026

(30) Foreign Application Priority Data
Mar. 25, 2025 (JP) 2025-050073

(51) Int. Cl. H01M 4/36; H01M 4/02; H01M 4/38; H01M 10/054

(52) U.S. Cl. CPC H01M 4/364; H01M 4/38; H01M 10/054; H01M 2004/021; H01M 2004/027

(57) ABSTRACT

In a phosphorus-carbon electrode active material composite for a sodium-ion battery according to the present disclosure, phosphorus and carbon are present in a dispersed state. The ratio of the specific surface area of a carbon material as a carbon source to the specific surface area of a phosphorus material as a phosphorus source is 90 to 24000. A sodium-ion battery according to the present disclosure includes an electrode active material layer, and the electrode active material layer includes the phosphorus-carbon electrode active material composite according to the present disclosure.

### CROSS-REFERENCE TO RELATED APPLICATION

This application claims priority to Japanese Patent Application No. 2025-050073 filed on Mar. 25, 2025. The disclosure of the above-identified application, including the specification, drawings, and claims, is incorporated by reference herein in its entirety.

### BACKGROUND

### 1. Technical Field

The present disclosure relates to a phosphorus-carbon electrode active material composite for a sodium-ion battery, and to the sodium-ion battery.

### 2. Description of Related Art

Japanese Unexamined Patent Application Publication No. 2021-192349 (JP 2021-192349 A) discloses an all-solid-state sodium battery in which an anode layer contains a phosphorus-carbon composite (phosphorus-carbon electrode active material composite) as an anode active material.

Phosphorus in the phosphorus-carbon electrode active material composite reacts with sodium to form an alloy. That is, phosphorus serving as an electrode active material stores and releases sodium ions, and is therefore involved in charging and discharging of the battery.

As disclosed in Japanese Unexamined Patent Application Publication No. 2022-117834 (JP 2022-117834 A), it is known that, in batteries containing silicon as an electrode active material, the silicon expands and contracts along with charging and discharging.

### SUMMARY

The present disclosers have found that, as in the case of silicon, phosphorus in the phosphorus-carbon electrode active material composite may expand and contract along with charging and discharging of the battery.

An object of the present disclosure is to provide a phosphorus-carbon electrode active material composite for a sodium-ion battery that can mitigate the effects of phosphorus expansion and contraction along with charging and discharging of the battery, and to provide a sodium-ion battery including the phosphorus-carbon electrode active material composite.

The present disclosers have found that the above issue can be solved by the following means.

### First Aspect

A phosphorus-carbon electrode active material composite for a sodium-ion battery, the phosphorus-carbon electrode active material composite including phosphorus and carbon that are present in a dispersed state, in which
a ratio of a specific surface area of a carbon material as a carbon source to a specific surface area of a phosphorus material as a phosphorus source is 90 to 24000.

### Second Aspect

The phosphorus-carbon electrode active material composite according to the first aspect, in which:
the phosphorus material is red phosphorus, black phosphorus, or a combination of the red phosphorus and the black phosphorus; and
the carbon material is graphite, non-fibrous carbon particles, porous carbon, or any combination of the graphite, the non-fibrous carbon particles, and the porous carbon.

### Third Aspect

The phosphorus-carbon electrode active material composite according to the first aspect, in which:
the ratio is 500 to 3000;
the phosphorus material is red phosphorus; and
the carbon material is acetylene black.

### Fourth Aspect

A sodium-ion battery including an electrode active material layer, in which
the electrode active material layer includes the phosphorus-carbon electrode active material composite according to any one of the first to third aspects.

### Fifth Aspect

The sodium-ion battery according to the fourth aspect, in which the sodium-ion battery is a liquid battery.

According to the present disclosure, it is possible to provide the phosphorus-carbon electrode active material composite for the sodium-ion battery that can mitigate the effects of phosphorus expansion and contraction along with charging and discharging of the battery, and to provide the sodium-ion battery including the phosphorus-carbon electrode active material composite.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view showing an example of a sodium-ion battery according to the present disclosure; and

FIG. 2 is a graph showing the relationship between the ratio of the specific surface area of a carbon material to the specific surface area of a phosphorus material in each of phosphorus-carbon electrode active material composites of Examples and Comparative Examples and an expansion rate of an anode active material layer containing the composite.

### DETAILED DESCRIPTION OF EMBODIMENTS

An embodiment of the present disclosure will be described below in detail. The present disclosure is not limited to the embodiment described below, and various modifications may be made within the scope of the present disclosure.

### Phosphorus-Carbon Electrode Active Material Composite for Sodium-Ion Battery

In a phosphorus-carbon electrode active material composite for a sodium-ion battery according to the present disclosure, phosphorus and carbon are present in a dispersed state. The ratio of the specific surface area of a carbon material as a carbon source to the specific surface area of a phosphorus material as a phosphorus source is 90 to 24000.

The present disclosers have found that the phosphorus-carbon electrode active material composite according to the present disclosure in which the ratio of the specific surface area of the carbon material as the carbon source to the specific surface area of the phosphorus material as the phosphorus source (hereinafter may be simply referred to as “the ratio of the specific surface area of the carbon material to the specific surface area of the phosphorus material”) is within the predetermined range can mitigate the effects of phosphorus expansion and contraction along with charging and discharging of the battery.

The reason for this is presumed to be as follows, without intending to be bound by any theory. That is, in the phosphorus-carbon electrode active material composite according to the present disclosure, the ratio of the specific surface area of the carbon material to the specific surface area of the phosphorus material is within the predetermined range, Therefore, it is believed that aggregation of phosphorus and carbon is suppressed in the manufacturing process of the composite, and thus phosphorus and carbon are well dispersed within the composite. It is believed that local expansion and contraction of phosphorus is unlikely to occur when phosphorus serving as an electrode active material to store and release sodium ions is well dispersed in the composite. As a result, it is believed that the phosphorus-carbon electrode active material composite according to the present disclosure can mitigate the effects of phosphorus expansion and contraction along with charging and discharging of the battery.

In the present disclosure, the “phosphorus-carbon electrode active material composite for the sodium-ion battery” may be simply referred to as “phosphorus-carbon electrode active material composite” or “composite.”

The “electrode active material” may be “anode active material” or “cathode active material,” and may particularly be “anode active material.”

Hereinafter, each element that can constitute the phosphorus-carbon electrode active material composite according to the present disclosure will be described.

In the phosphorus-carbon electrode active material composite according to the present disclosure, phosphorus and carbon are present in a dispersed state. Phosphorus and carbon may be dispersed particularly in nanometer order. Phosphorus and carbon may be partially combined or dissolved with each other.

As described above, phosphorus reacts with sodium to form an alloy. That is, phosphorus serving as the electrode active material stores and releases sodium ions, and is therefore involved in charging and discharging of the battery.

Specific phosphorus materials as phosphorus sources will be described later.

Carbon may have relatively high electronic conductivity. In this case, carbon can function as a conductive aid in the composite. Without intending to be bound by any theory, it is believed that, when carbon having relatively high electronic conductivity is well dispersed within the composite, uneven reaction is less likely to occur, and thus local expansion and contraction of phosphorus is unlikely to occur. As a result, it is believed that the effects of phosphorus expansion and contraction along with charging and discharging of the battery can be mitigated effectively.

Carbon may or may not be involved in charging and discharging of the battery.

Specific carbon materials as carbon sources will be described later.

In the phosphorus-carbon electrode active material composite according to the present disclosure, the ratio of the specific surface area of the carbon material as the carbon source to the specific surface area of the phosphorus material as the phosphorus source is 90 to 24000. This can mitigate the effects of phosphorus expansion and contraction along with charging and discharging of the battery.

The ratio of the specific surface area of the carbon material to the specific surface area of the phosphorus material may be 100 to 20000, 300 to 15000, or 500 to 3000. This value may be 100 or more, 300 or more, 500 or more, or 700 or more, and may be 24000 or less, 20000 or less, 19000 or less, 15000 or less, 10000 or less, 5000 or less, 3000 or less, 2500 or less, 1500 or less, 1300 or less, 1000 or less, or 800 or less. This can effectively mitigate the effects of phosphorus expansion and contraction along with charging and discharging of the battery.

The specific surface area of the phosphorus material may be 0.010 m²/g to 0.10 m²/g, 0.030 m²/g to 0.080 m²/g, or 0.050 m²/g to 0.060 m²/g. The specific surface area of the phosphorus material may be 0.010 m²/g or more, 0.020 m²/g or more, 0.030 m²/g or more, 0.040 m²/g or more, or 0.050 m²/g or more, and may be 0.10 m²/g or less, 0.090 m²/g or less, 0.080 m²/g or less, 0.070 m²/g or less, or 0.060 m²/g or less.

The specific surface area of the carbon material may be 5 m²/g to 1300 m²/g, 10 m²/g to 1000 m²/g, or 30 m²/g to 150 m²/g. The specific surface area of the carbon material may be 5 m²/g or more, 10 m²/g or more, 20 m²/g or more, 30 m²/g or more, or 35 m²/g or more, and may be 1300 m²/g or less, 1000 m²/g or less, 700 m²/g or less, 500 m²/g or less, 300 m²/g or less, 150 m²/g or less, 100 m²/g or less, 70 m²/g or less, 50 m²/g or less, or 40 m²/g or less.

The specific surface area can be measured by the BET method.

The phosphorus material is not particularly limited, and examples thereof include elemental phosphorus and phosphorus compounds. Examples of elemental phosphorus include red phosphorus and black phosphorus.

The phosphorus material may particularly be red phosphorus, black phosphorus, or a combination thereof. This can effectively mitigate the effects of phosphorus expansion and contraction along with charging and discharging of the battery.

The carbon material may be graphite, non-fibrous carbon particles, porous carbon, or a combination thereof. This can effectively mitigate the effects of phosphorus expansion and contraction along with charging and discharging of the battery. The carbon material may be graphite, non-fibrous carbon particles, or porous carbon, and particularly non-fibrous carbon particles. Graphite and fibrous carbon particles have relatively high electronic conductivity.

The graphite is not particularly limited, and may be, for example, artificial graphite or natural graphite.

The non-fibrous carbon particles are not particularly limited, and may be, for example, carbon black. The carbon black is not particularly limited, and may be, for example, acetylene black, Ketjen black, furnace black, or a combination thereof, and particularly acetylene black. Examples of the acetylene black include DENKA BLACK Li-100 (specific surface area: 68 m²/g), DENKA BLACK Li-400 (specific surface area: 39 m²/g), and DENKA BLACK Li-435 (specific surface area: 133 m²/g) that are produced by DENKA Corporation.

The porous carbon is not particularly limited, and may be, for example, activated carbon.

In terms of electronic conductivity, the carbon material may be a material including sp²-bonded carbon. The carbon material may include only sp²-bonded carbon, or may include both sp²-bonded carbon and sp³-bonded carbon. The proportion of sp²-bonded carbon to the total of sp²-bonded carbon and sp³-bonded carbon is not particularly limited, and may be, for example, 50 mol % or more. Examples of such carbon materials include graphite and non-fibrous carbon particles described above.

The phosphorus material and the carbon material are not limited to the above materials and may be any combination, as long as the ratio of the specific surface area of the carbon material to the specific surface area of the phosphorus material can be within the range of the present disclosure.

The shape and size of the composite are not particularly limited.

In the composite, the mass ratio of phosphorus to carbon may be from 6:4 to 9:1, or from 7:3 to 8:2. In terms of battery capacity, the ratio of phosphorus may be high. In terms of mitigation of the effects of phosphorus expansion and contraction, the ratio of carbon may be high.

The composite may contain only phosphorus and carbon, or may further contain other elements. Examples of other elements include ion-conductive metal elements. Examples of ion-conductive metal elements include sodium and lithium. The number of types of ion-conductive metal elements may be one, or may be two or more.

The composite may contain, for example, at least one of a metal element and a metalloid element belonging to groups 3 to 16 of the periodic table, but may contain neither of them.

The composite may or may not further contain oxygen, sulfur, and halogens. Examples of halogens include chlorine, bromine, and iodine. The number of types of halogens may be one, or may be two or more.

In the composite, the total proportion of phosphorus and carbon is not particularly limited, and may be, for example, 50 mol % or more, 70 mol % or more, 90 mol % or more, or 100 mol % with respect to all constituent elements. “All constituent elements” do not include elements that are inevitably contained in the composite, such as oxygen adsorbed on the surface.

### Method for Producing Phosphorus-Carbon Electrode Active Material Composite

The phosphorus-carbon electrode active material composite according to the present disclosure can be produced by a method including the following step:
mechanically milling a phosphorus material as a phosphorus source and a carbon material as a carbon source, in which
the ratio of the specific surface area of the carbon material as the carbon source to the specific surface area of the phosphorus material as the phosphorus source is 90 to 24000.

For the phosphorus material and the carbon material, reference may be made to the above description.

The mechanical milling is not particularly limited, and examples thereof include processing methods using a ball mill such as a planetary ball mill, a vibration mill, a turbo mill, and a disc mill.

When a planetary ball mill is used, the raw material mixture and milling balls may be placed in a pot and processed at a predetermined table rotation speed for a predetermined time. This processing may be performed under an inert atmosphere.

The table rotation speed in the ball milling is not particularly limited, and may be, for example, 200 rpm or more, 400 rpm or more, or 500 rpm or more, and may be 800 rpm or less, 600 rpm or less, or 500 rpm or less.

The processing time is not particularly limited, and may be, for example, 15 hours or more, 20 hours or more, or 24 hours or more, and may be 50 hours or less, 30 hours or less, or 25 hours or less.

The method of the present disclosure may include mixing the phosphorus material and the carbon material prior to the mechanical milling. The mixing method is not particularly limited, and examples thereof include a method of mixing in a mortar.

### Electrode Composite Material

The phosphorus-carbon electrode active material composite for the sodium-ion battery according to the present disclosure can be used together with other optional components to form an electrode composite material. That is, the electrode composite material contains the phosphorus-carbon electrode active material composite, and may contain other optional components. Examples of other optional components include a conductive aid and a binder.

In the present disclosure, the term “electrode composite material” refers to a composition by which an electrode active material layer can be made, either by itself or in further combination with other components. In the present disclosure, the term “electrode composite material slurry” refers to a slurry that contains a dispersion medium in addition to the “electrode composite material” and that can be applied and dried to form an electrode active material layer.

In the present disclosure, the “electrode composite material” may be either a “cathode composite material” or an “anode composite material” and may particularly be an “anode composite material.”

Hereinafter, each element that can constitute the electrode composite material will be described.

### Phosphorus-Carbon Electrode Active Material Composite for Sodium-Ion Battery

For the phosphorus-carbon electrode active material composite for the sodium-ion battery, reference may be made to the above description.

The content of the composite in the electrode composite material is not particularly limited, and can be set as appropriate in consideration of desired battery capacity etc. The content of the composite in the electrode composite material may be, for example, 50 mass % or more, 70 mass % or more, or 80 mass % or more, and may be 100 mass % or less, 90 mass % or less, or 80 mass % or less.

The electrode composite material may or may not contain an electrode active material other than the composite.

### Conductive Aid

The conductive aid is not particularly limited, and may be, for example, a carbon material or a metal material. Examples of the carbon material include carbon black such as acetylene black, Ketjen black, furnace black, and thermal black, carbon fibers such as carbon nanotubes and vapor grown carbon fibers (VGCF), graphite, hard carbon, and coke. Examples of the metal material include Fe, Cu, Ni, and Al. The conductive aid may be one or more types of the above materials.

The content of the conductive aid in the electrode composite material is not particularly limited, and can be set as appropriate in consideration of desired conductivity etc.

### Binder

Examples of the binder include fluorine-based binders such as polyvinylidene fluoride (PVdF)-based binders and polytetrafluoroethylene (PTFE)-based binders, rubber-based binders such as styrene butadiene rubber (SBR)-based binders, olefin-based binders such as polypropylene (PP)-based binders and polyethylene (PE)-based binders, cellulose-based binders such as carboxymethyl cellulose (CMC)-based binders, and polyacrylic acid (PAA)-based binders. The binder may be one or more types of the above materials.

The content of the binder in the electrode composite material is not particularly limited, and can be set as appropriate in consideration of desired binding properties etc.

### Sodium-Ion Battery

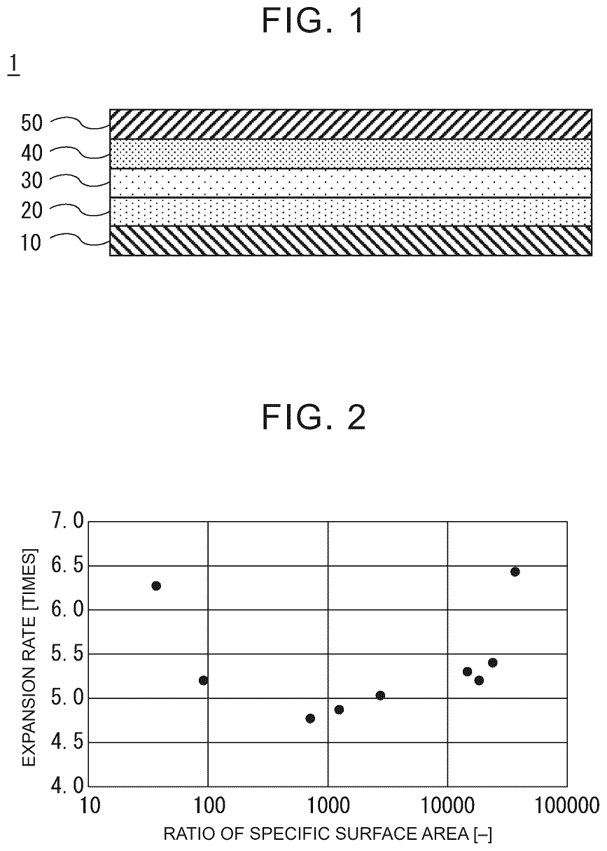

The sodium-ion battery according to the present disclosure includes an electrode active material layer, and the electrode active material layer includes the phosphorus-carbon electrode active material composite according to the present disclosure. As exemplified in FIG. 1, a sodium-ion battery 1 according to the present disclosure may include an anode current collector layer 10, an anode active material layer 20, an electrolyte layer 30, a cathode active material layer 40, and a cathode current collector layer 50 in this order. In the sodium-ion battery according to the present disclosure, in particular, the anode active material layer may include the phosphorus-carbon electrode active material composite according to the present disclosure.

The sodium-ion battery according to the present disclosure may be a solid-state battery or a liquid battery, and particularly a liquid battery.

The electrolyte layer of the liquid battery may include an electrolyte solution having sodium ions.

In the present disclosure, the “solid-state battery” refers to a battery that contains at least a solid electrolyte as an electrolyte, and therefore the solid-state battery may be a combination of a solid electrolyte and a liquid electrolyte as the electrolyte. The solid-state battery may also be an all-solid-state battery, i.e., a battery containing only a solid electrolyte as the electrolyte. Thus, when the sodium-ion battery according to the present disclosure is the solid-state battery, the electrolyte layer may include a solid electrolyte having sodium ions.

The sodium-ion battery according to the present disclosure may be a secondary battery.

The sodium-ion battery may be, for example, in the form of a coin, a laminate (pouch), a cylinder, or a prism.

The sodium-ion battery can be manufactured, for example, by forming each of the above layers in a dry or wet manner.

The sodium-ion battery according to the present disclosure can be suitably used in at least one type of vehicle that is selected from, for example, a hybrid electric vehicle (HEV), a plug-in hybrid electric vehicle (PHEV), and a battery electric vehicle (BEV).

Each element constituting the battery according to the present disclosure will be described below. The following exemplifies a case where the battery according to the present disclosure is a liquid battery and the electrode active material layer according to the present disclosure is an anode active material layer.

### Anode Current Collector Layer

Examples of materials for the anode current collector layer include SUS, aluminum, copper, nickel, and carbon. The anode current collector layer may be made of a porous metal body.

### Anode Active Material Layer

The anode active material layer includes the phosphorus-carbon electrode active material composite for the sodium-ion battery according to the present disclosure. For the phosphorus-carbon electrode active material composite for the sodium-ion battery according to the present disclosure, reference may be made to the above description. The anode active material layer may be obtained by forming, into a sheet shape, the electrode composite material containing the phosphorus-carbon electrode active material composite for the sodium-ion battery according to the present disclosure.

### Electrolyte Layer

The electrolyte layer may be formed by impregnating a separator with an electrolyte solution.

### Separator

The separator is not particularly limited as long as it has a function of electrically separating the anode active material layer and the cathode active material layer. The separator may be, for example, a porous sheet made of a resin such as polyethylene (PE), polypropylene (PP), polyester, cellulose, or polyamide, a porous insulating material such as a nonwoven fabric or a glass fiber nonwoven fabric, or a combination thereof.

### Electrolyte Solution

The electrolyte solution may contain a sodium salt and a non-aqueous solvent.

The sodium salt is not particularly limited, and may be, for example, an inorganic sodium salt such as NaPF₆, NaBF₄, NaClO₄, or NaAsF₆, an organic sodium salt such as NaCF₃SO₃, NaN(CF₃SO₂)₂, NaN(C₂F₅SO₂)₂, NaN(FSO₂)₂, or NaC(CF₃SO₂)₃, or a combination thereof.

The non-aqueous solvent is not particularly limited as long as it dissolves the sodium salt. The non-aqueous solvent may be a high dielectric constant solvent, a low dielectric constant solvent, or a combination thereof. The high dielectric constant solvent may be, for example, a cyclic ester (cyclic carbonate) such as ethylene carbonate (EC), propylene carbonate (PC), or butylene carbonate (BC), γ-butyrolactone, sulfolane, N-methyl-2-pyrrolidone (NMP), 1,3-dimethyl-2-imidazolidinone (DMI), or a combination thereof. The low dielectric constant solvent may be, for example, a chain ester (chain carbonate) such as dimethyl carbonate (DMC), diethyl carbonate (DEC), or ethyl methyl carbonate (EMC), an acetate such as methyl acetate or ethyl acetate, an ether such as 2-methyltetrahydrofuran, or a combination thereof.

### Cathode Active Material Layer

The cathode active material layer contains a cathode active material, and may optionally contain a conductive aid, a binder, etc.

### Cathode Active Material

The cathode active material is not particularly limited as long as it exhibits a noble potential relative to the anode active material. Examples of the cathode active material include a Na-containing oxide such as a layered active material, a spinel active material, and an olivine active material. Specific examples include NaFeO₂, NaNiO₂, NaCoO₂, NaMnO₂, NaVO₂, Na(NiₓMn₁₋ₓ)O₂ (0<x<1), Na(FeₓMn₁₋ₓ)O₂ (0<x<1), NaVPO₄F, Na₂FePO₄F, and Na₃V₂(PO₄)₃.

The content of the cathode active material in the cathode active material layer is not particularly limited, and can be set as appropriate in consideration of desired battery capacity etc.

The shape and size of the cathode active material are not particularly limited.

### Conductive Aid and Binder

For the conductive aid and the binder, reference may be made to the above description.

### Cathode Current Collector Layer

Examples of materials for the cathode current collector layer include SUS, aluminum, nickel, iron, titanium, and carbon.

### Shape and Thickness of Each Layer

The shape of each layer is not particularly limited, and may be, for example, a sheet shape having a substantially flat surface.

The thickness of each layer is not particularly limited, and can be adjusted as appropriate depending on the configuration of the battery.

### Other Configurations

The sodium-ion battery according to the present disclosure may include a battery case that houses the above layers, and terminals connected to the current collector layers etc. These may be those commonly used for sodium-ion batteries.

### Example 1

### Preparation of Phosphorus-Carbon Electrode Active Material Composite

Red phosphorus (produced by Kojundo Chemical Lab. Co., Ltd., specific surface area: 0.055 m²/g) as a phosphorus source and artificial graphite as a carbon source were weighed at a mass ratio of 7:3, totaling 5 g. These were mixed in a mortar, and the mixture was placed in a ball mill pot together with 96 g of 95 zirconia balls. The ball mill pot was purged with argon gas and then sealed, and the raw material mixture was subjected to ball milling. The ball milling was performed at a table rotation speed of 500 rpm for 24 hours. As a result, a phosphorus-carbon electrode active material composite of Example 1 was obtained.

### Fabrication of Battery

The phosphorus-carbon electrode active material composite, carbon nanotubes, and polyvinylidene fluoride were weighed at a mass ratio of 8:1:1, and these were dispersed and mixed in N-methyl-2-pyrrolidone to prepare an electrode composite material slurry. The obtained electrode composite material slurry was applied to a copper foil (thickness: 10 μm) as a current collector layer. The electrode composite material slurry was dried to obtain an electrode laminate, and the electrode laminate was pressed to a thickness of 30 μm and dried under vacuum at 80° C. overnight to obtain a sample electrode. In this sample electrode, the thickness of the electrode active material layer containing the phosphorus-carbon electrode active material composite was 20 μm. The coating weight of the electrode active material layer was 1.5 mg/cm².

A metallic sodium foil was used as a counter electrode, and 1 M of NaPF₆ (EC:DEC=1:1 vol, FEC at 3 mass %) was used as an electrolyte solution. As a result, a battery of Example 1 (CR2032 coin cell) was obtained.

### Examples 2 to 7 and Comparative Examples 1 and 2

Batteries of Examples 2 to 7 and Comparative Examples 1 and 2 were obtained in the same manner as in Example 1, except that the carbon source was changed to carbon materials shown in Table 1.

### Reference Example

A battery of Reference Example was obtained in the same manner as in Example 1, except that no carbon material was used.

### Expansion Rate Evaluation

The battery of each example was charged in a thermostatic chamber at 25° C. in a voltage range of 0.01 V to 2.0 V at a rate of 0.1 C. The thicknesses of the electrode active material layer before and after the initial charging were measured using a constant pressure thickness gauge (PG-15A, manufactured by Teclock Corporation). A value obtained by dividing the thickness of the electrode active material layer after charging by the thickness of the electrode active material layer before charging was defined as an expansion rate. Therefore, the expansion rate indicates how many times the thickness of the electrode active material layer after charging increased compared to the thickness of the electrode active material layer before charging. The expansion rate is an index showing the magnitude of the expansion amount of the phosphorus-carbon electrode active material composite.

The results are shown in Table 1 and FIG. 2. In Table 1 and FIG. 2, “ratio of specific surface area” means the ratio of the specific surface area of the carbon material to the specific surface area of the phosphorus material. In FIG. 2, “ratio of specific surface area” is shown as a common logarithm, and the result of Reference Example is excluded.

TABLE 1

| | | | Expansion rate evaluation | | |
|---|---|---|---|---|---|
| | | Ratio of | Thickness of electrode | | |
| | | specific | active material layer [um] | | Expansion |
| | Carbon | surface | Before | After | rate |
| | material | area [-] | charging | charging | [times] |
| Comparative | Hard carbon | 37 | 20 | 125 | 6.3 |
| Example 1 | | | | | |
| Example 1 | Artificial | 92 | 20 | 104 | 5.2 |
| | graphite | | | | |
| Example 2 | Acetylene | 715 | 20 | 95 | 4.8 |
| | black | | | | |
| | (DENKA | | | | |
| | BLACK Li- | | | | |
| | 400) | | | | |
| Example 3 | Acetylene | 1247 | 20 | 97 | 4.9 |
| | black | | | | |
| | (DENKA | | | | |
| | BLACK Li- | | | | |
| | 100) | | | | |
| Example 4 | Acetylene | 2440 | 20 | 101 | 5.0 |
| | black | | | | |
| | (DENKA | | | | |
| | BLACK Li- | | | | |
| | 435) | | | | |
| Example 5 | Ketjen black | 14667 | 20 | 106 | 5.3 |
| Example 6 | Activated | 18333 | 20 | 104 | 5.2 |
| | carbon | | | | |
| Example 7 | Ketjen black | 23833 | 20 | 108 | 5.4 |
| | (High | | | | |
| | specific | | | | |
| | surface area | | | | |
| | product) | | | | |
| Comparative | SWCNT | 36667 | 20 | 129 | 6.4 |
| Example 2 | | | | | |
| Reference | | - | 20 | 114 | 5.7 |
| Example | | | | | |

As shown in Table 1, the expansion rates were small in the electrode active material layers of Examples containing the phosphorus-carbon electrode active material composites in which the ratio of the specific surface area of the carbon material to the specific surface area of the phosphorus material was within the range of the present disclosure.

What is claimed is:

1. A phosphorus-carbon electrode active material composite for a sodium-ion battery, the phosphorus-carbon electrode active material composite comprising phosphorus and carbon that are present in a dispersed state, wherein
a ratio of a specific surface area of a carbon material as a carbon source to a specific surface area of a phosphorus material as a phosphorus source is 90 to 24000.

2. The phosphorus-carbon electrode active material composite according to claim 1, wherein:
the phosphorus material is red phosphorus, black phosphorus, or a combination of the red phosphorus and the black phosphorus; and
the carbon material is graphite, non-fibrous carbon particles, porous carbon, or any combination of the graphite, the non-fibrous carbon particles, and the porous carbon.

3. The phosphorus-carbon electrode active material composite according to claim 1, wherein:
the ratio is 500 to 3000;
the phosphorus material is red phosphorus; and
the carbon material is acetylene black.

4. A sodium-ion battery comprising an electrode active material layer, wherein
the electrode active material layer includes the phosphorus-carbon electrode active material composite according to claim 1.

5. The sodium-ion battery according to claim 4, wherein the sodium-ion battery is a liquid battery.
